(19) United States
(12) Patent Application Publication
(10) Pub. No.: US 2012/0306235 A1
(43) Pub. Date: Dec. 6, 2012

(54) RESTRAINING DEVICE, SHADING SYSTEM, MOTOR VEHICLE AND RELATED METHOD

(75) Inventors: Bernd Weber, Nauheim (DE); Thomas Bietz, Taunusstein (DE); Holger Hanfeld, Wiesbaden (DE); Frank Annawald, Langen (DE)

(73) Assignee: GM GLOBAL TECHNOLOGY OPERATIONS LLC, Detroit, MI (US)

(21) Appl. No.: 13/483,415

(22) Filed: May 30, 2012

(30) Foreign Application Priority Data
May 31, 2011 (DE) 10 2011 102 895.5

(51) Int. Cl. F16F 7/12; B60J 10/12

(52) U.S. Cl. 296/187.05; 296/216.08; 188/377

(57) ABSTRACT

A restraining device of a shading system for absorbing the kinetic energy of a slidable shading arrangement given an unforeseen movement is provided. The restraining device includes a first restraining arrangement configured to absorb a first portion of the kinetic energy by at least partially deforming.

### CROSS-REFERENCE TO RELATED APPLICATION

This application claims priority to German Patent Application No. 10 2011 102 895.5, filed May 31, 2011, which is incorporated herein by reference in its entirety.

### TECHNICAL FIELD

The technical field generally relates to a restraining device for a shading system, in particular an overhead shading system in a motor vehicle, for absorbing the kinetic energy of a slidable shading arrangement given an unforeseen movement.

### BACKGROUND

Shading systems for motor vehicles are known in the art. In simple configurations, the shading systems are designed as foldable sun visors or openable and closable sunshades on a roof region of the motor vehicle. Also known are shading systems in the form of slidable shading modules, above all in (sun)light-permeable panoramic vehicle roofs. These slidable shading modules are mounted in lateral rails on the motor vehicle roof. Depending on how the sunlight falls inside the motor vehicle, the shading modules can be aligned in any shading positions desired along a longitudinal axis of the motor vehicle, wherein the vehicle roof itself is not opened. In case of an accident involving the motor vehicle or generally in the event of high, abrupt and unforeseen negative accelerations acting on the motor vehicle or shading module, the inertia of the shading module causes it to move unimpeded and uncontrolled along the rails in the acceleration direction, i.e., opposite the negative acceleration direction, so that it no longer is held by one end of the rails. As a result, the shading module is thrown into the interior along the windshield of the motor vehicle, and/or smashes through the windshield. The mount in which the shading module is guided and held is here also uncontrollably destroyed. This uncontrollable reaction poses a risk to the vehicle passengers in case of an accident. No known solutions for preventing this uncontrolled movement or absorbing the kinetic energy of a shading module have thus far come to light.

U.S. Pat. No. 4,363,515 describes a sunroof for motor vehicles with a rigid slide cover, which seals a roof opening in the closed position, and can be lowered out of the latter and slid under the fixed rear roof section. Therefore, the slide cover opens the vehicle roof. The sunroof is characterized in that the slide cover is provided with a collision safeguard to prevent the at least partially opened slide cover from unintentionally closing. In an embodiment, the collision safeguard is designed as at least one automatic safety belt extending between the slide cover and fixed roof section.

Therefore, at least one object herein is to provide a restraining device for shading systems for vehicle roofs, which makes it possible to slow down the shading arrangement given an uncontrolled movement, thereby ensuring that the vehicle passengers are protected. In particular, an object herein is to provide a shading system and motor vehicle, as well as a related method. In addition, other objects, desirable features and characteristics will become apparent from the subsequent summary and detailed description, and the appended claims, taken in conjunction with the accompanying drawings and this background.

### SUMMARY

In order to absorb the kinetic energy of a slidable shading arrangement given an unforeseen movement, the various embodiments herein utilize a first restraining arrangement in a restraining device for a shading system, in particular an overhead shading system in a motor vehicle, so that at least a partial deformation absorbs a first portion of the kinetic energy.

Such a restraining device for shading systems ensures that the shading arrangement is slowed down given a sudden and unforeseen movement, i.e., that its kinetic energy is absorbed. This prevents the shading arrangement from being ripped out of its mount and thrown uncontrollably through or out of the motor vehicle. The restraining device provides additional protection to passengers in case of an accident.

In an embodiment, the shading arrangement is slidably mounted in guiding rails. On the one hand, the sliding operation can be initiated by hand or motorized, but in an intentional and foreseen manner. On the other hand, the sliding operation for the shading arrangement can be triggered in an unforeseen and unintentional manner, for example in case of an accident. High, negative acceleration forces here act on the shading arrangement. If the shading arrangement then hits one end of the guiding rails without being decelerated, its kinetic energy is suddenly released, and destroys the guiding rails, so that the shading arrangement is no longer held. A restraining device absorbs the released kinetic energy of the shading arrangement, thereby preventing the shading arrangement from smashing through the guiding rails at a front end of the latter viewed in the acceleration direction. The first restraining arrangement here absorbs the first portion of kinetic energy. In an embodiment, absorption by the first restraining arrangement takes place by at least partially deforming this restraining arrangement. Kinetic energy is converted into deformation energy and/or heat in the process. The kinetic energy is here predominantly or exclusively absorbed by the first restraining arrangement, and not by the guiding arrangement or the like. The first restraining arrangement is designed as a single part in an embodiment, and consists of two or more parts in an embodiment. Depending on the configuration, a first restraining arrangement or several first restraining arrangements are provided.

The first restraining arrangement is preferably immovably fixed in place. As a result, the distance between the restraining arrangement and shading system varies as a function of the shading system position. In light of the differing positions of the shading arrangement, and hence the varying distance between the restraining arrangement and shading system, the kinetic energy to be absorbed by the restraining arrangement varies in magnitude. Therefore, another embodiment provides that the first restraining arrangement be furnished at a constant distance from the shading system. To this end, one embodiment involves slidably configuring the first restraining arrangement with the shading system or without the shading system. Latching arrangements are here provided, ensuring that the first restraining arrangement is fixed in place. If the first restraining arrangement is immovably fixed in place, the kinetic energy to be absorbed cannot be precisely determined. For reasons of space, it is not always possible to absorb the maximum arising kinetic energy by means of a first restraining arrangement with sufficient certainty.

Therefore, an embodiment of the restraining device provides that a second restraining arrangement be configured to absorb a second portion of the kinetic energy. The two restraining arrangements are coupled with each other, in particular functionally connected. The second portion of the kinetic energy preferably corresponds to the difference in energy between the overall kinetic energy and the first portion of kinetic energy, so as to completely absorb the kinetic energy. For example, the second portion of kinetic energy is converted into friction and/or heat. After this, the shading arrangement is stopped completely. The second restraining arrangement is configured as a single part in an embodiment, and consists of two or more parts in an embodiment. In another embodiment, the first and second restraining arrangements are situated and/or configured so as to at least partially act in parallel. One embodiment provides that the two restraining arrangements exert a time-displaced and/or position-displaced effect. For example, it is provided that a first restraining arrangement acts first, absorbing the kinetic energy through deformation. The second restraining arrangement exerts a supplementary effect even before the first restraining arrangement has undergone complete deformation or before the first portion of kinetic energy has been completely absorbed. This ensures that the actions of the two restraining arrangements will overlap. Several restraining arrangements are provided in another embodiment. For example, two or more first restraining arrangements are provided, along with a second restraining arrangement. The second restraining arrangement is configured in such a way, for example, as to act after the first restraining arrangement has absorbed a portion of the kinetic energy, and before the second first restraining arrangement even responds at all. Other embodiments and configurations are conceivable.

Another embodiment of the restraining device provides that the first restraining arrangement and second restraining arrangement are at least in part functionally connected in sequence, so as to doubly ensure that all kinetic energy is absorbed. The kinetic energy of the shading arrangement is absorbed in two stages. In a first stage, the first portion of the kinetic energy is absorbed by the first restraining arrangement. In a second stage, the second portion of the kinetic energy is absorbed by the second restraining arrangement, wherein the stages can overlap, although this is avoided. Absorption by the second restraining arrangement preferably takes place only after absorption by the first restraining arrangement has concluded.

The first absorbed portion of kinetic energy is greater than or equal to, preferably greater than, the second absorbed portion of kinetic energy, so that the first restraining arrangement absorbs most of the kinetic energy. In an embodiment, the first portion of kinetic energy measures at least 50%, for example, at least 75%, such as at least 90%, of the overall kinetic energy of the shading arrangement. As a consequence, the first restraining arrangement is the principal restraining arrangement. The second restraining arrangement is placed downstream from the first restraining arrangement as a safety feature. Depending on how large a portion of kinetic energy was absorbed by the first restraining arrangement, the second restraining arrangement need not be used. However, the second restraining arrangement can always be set up as a redundancy and safeguard. In a configuration without a second restraining arrangement, the first restraining arrangement absorbs a portion of kinetic energy measuring at least 90% of the overall kinetic energy. The remaining, at most 10% of the kinetic energy can be absorbed by the guiding arrangement without deforming and destroying it. However, the guiding arrangement is not a constituent of the first restraining arrangement from the standpoint of this patent application.

An embodiment of the restraining device provides that the first restraining arrangement be designed as one or more plastically deformable absorption units. The first restraining arrangement is situated on the front end of the guiding rails viewed in the direction of a negative acceleration, i.e., next to a windshield or front of a motor vehicle. The first restraining arrangement is set up on both sides of the shading arrangement, meaning on the right and left sides. For example, the absorption unit is designed as a single piece or multiple pieces, such as two pieces. The absorption unit is used to convert the first portion of kinetic energy into deformation energy and heat. The absorption unit here absorbs the kinetic energy by at least partially deforming. For example, deformation takes place over a specific deformation path, wherein the deformation path depends on the amount of kinetic energy absorbed, the material comprising the absorption unit, and the design of the absorption unit. Predetermined breaking points, tapered sections of material and the like are prescribed for selectively steering the absorbed kinetic energy, so that a targeted deformation takes place. In one embodiment, deformation is realized as elastic deformation achieved through the appropriate selection of material, for example elastic materials or shape-memory materials. Plastic deformation is preferred in other embodiments.

As a result, the absorption unit is configured as a plastically deformable holding section in one embodiment. The holding section is configured as a single part to avoid weak points at the junctions between the several parts. In other embodiments, the holding section consists of multiple parts, for example two parts. For example, the holding section exhibits an approximately triangular shape that converges in the direction of movement. The holding section here exhibits a deforming region, for example one that consists of one layer or two layers, and is preferably folded, in its front region, meaning in the direction of a motor vehicle windshield. When the holding section slows down the shading arrangement, in particular the front deforming regions are deformed. The absorption unit absorbs a varying amount of kinetic energy, depending on the configuration of the deforming regions, i.e., one or two layers, and/or on the type of fold. In an embodiment of the holding section with a two-layer, in particular specially folded deforming region, the first restraining arrangement absorbs so much kinetic energy, for example at least 90%, that the second restraining arrangement need not be used.

The deformation of the absorption unit is irreversible, without signs of material fatigue, such as brittle fractures and/or cracks in the absorption units. For example, the absorption unit consists of a plastically deformable material, such as metal, iron, alloys, hard rubber, etc. The holder is here preferably designed as a thin-walled holder.

Another embodiment of the restraining device provides that the second restraining arrangement be configured as at least one belt system resembling a seat belt system with unwindable safety belt. Seat belt systems ensure that passengers are restrained during sudden accelerations of the vehicle, preferably during negative accelerations. However, a movement is possible up to a specific acceleration level. The restraint only takes place once a defined acceleration level has been reached or exceeded. As a result, the shading arrangement can be intentionally or predictably shifted without triggering the second restraining arrangement so as to slow down the shading arrangement. The seat belt system exhibits the unwindable safety belt, an unwinding unit with brake unit, and an attachment to the shading arrangement. The attachment to the shading arrangement, in particular the safety belt, is preferably rigid, meaning immovable in design. The unwinding unit is preferably secured to an immovable component of the motor vehicle, for example the roof area of the body. The safety belt then runs between the unwinding unit and the shading arrangement. For example, the safety belt is designed as a belt, strap or rope. Suitable materials for this purpose include a reinforced synthetic material. On the one hand, the safety belt exhibits a fixed, absolute length. On the other hand, the length of the safety belt is variably adjustable or can be changed through winding and unwinding on the unwinding unit. For example, the unwinding unit is designed as a reel or roll.

Therefore, another embodiment of the restraining device provides that a length of the safety belt be tailored to a deformation path of the absorption unit, so as to ensure a seamless absorption of the kinetic energy. The kinetic energy is preferably absorbed by the safety belt of the second restraining arrangement after absorption via the absorption unit of the first restraining arrangement has begun and/or concluded. Absorption with the absorption unit concludes once the absorption unit has deformed by a prescribed percentage, in particular even completely, meaning when the maximum deformation path has been reached. The safety belt of the second restraining arrangement preferably grips or holds the shading arrangement at that point, and absorbs the residual kinetic energy of the shading arrangement. For this purpose, the fixed length of the safety belt, and preferably also the variable length of the safety belt, is tailored to the deformation path. This prevents the safety belt from being restrained before the maximum deformation path of the absorption unit has been reached.

Therefore, yet another embodiment of the restraining device provides that the second restraining arrangement encompass at least one brake system resembling a centrifugal clutch and/or cable brake. In one embodiment, the restraining arrangement encompasses at least one belt system resembling a seat belt system, and a brake system resembling a centrifugal clutch and/or cable brake. In another embodiment, the restraining arrangement encompasses only the brake system resembling a centrifugal clutch and/or cable brake. One embodiment of the restraining arrangement involves a first, deformable restraining arrangement and a second restraining arrangement designed as a centrifugal clutch and/or cable brake. In this case, the centrifugal clutch or cable brake replaces the belt system. However, both are optional once the first restraining arrangement has absorbed a correspondingly large portion of kinetic energy, meaning nearly all of the kinetic energy.

The belt system and brake system, i.e., the centrifugal clutch and cable brake, are equivalent. The restraining device has a redundant configuration, meaning at least two components are provided, for example a belt system and a centrifugal clutch or cable brake, or alternatively a centrifugal clutch and a cable brake. In an embodiment with two belt systems, a centrifugal clutch and/or a cable brake is provided. One embodiment provides that a brake system be configured as a radial or tangential centrifugal clutch and/or cable brake with brake shoes on both sides.

The brake system of the second restraining arrangement is situated on the belt system of the second restraining arrangement, in particular the safety belt. The belt system and brake system are here functionally connected. In an embodiment, the brake system engages the safety belt of the belt system.

An embodiment of the shading system provides that a switch unit be designed for switching the restraining device. The restraining device can be switched on and off with the switching unit. For example, the restraining device can be switched off during maintenance work. In one embodiment, the switch unit can be coupled to an electronic unit, for example with an acceleration sensor and/or so as to be connected with other safety arrangements, such as an airbag.

In a shading system, in particular an overhead shading system for a motor vehicle, comprising a roof shading arrangement for at least partially shading a passenger compartment, a guiding arrangement situated under the roof for slidably accommodating the shading arrangement, and a restrainer for absorbing the kinetic energy of the shading arrangement given an unforeseen movement, the restrainer is configured as a restraining device described above.

The shading arrangement is used to at least partially shade passengers or a passenger compartment. In one embodiment, the shading arrangement exhibits an additional sunshade unit in the form of a sunblind that can be rolled up and down and/or folding sun visors. In another embodiment, the shading arrangement exhibits a gripping unit for manual activation, for example as a recess, molding and/or bracket. In yet another embodiment, the shading arrangement exhibits a drive unit in the form of an electric engine for motorized actuation. The shading arrangement preferably exhibits guiding units for mounted sliding.

The guiding arrangement preferably designed as a frame consists of a single part in one embodiment and of multiple parts in another embodiment, e.g., two, three or four parts. For example, the guiding device, more precisely the frame, exhibits a rectangular shape. The guiding device is secured to the roof of the motor vehicle, preferably integrated into the roof of the motor vehicle. In one embodiment, the guiding arrangement exhibits guiding rails, in which the shading arrangement is slidably mounted. Sliding, for example, takes place in two directions, meaning forward and reverse, wherein the sliding direction corresponds to the direction of an acceleration triggered by the kinetic energy of the shading arrangement. The shading arrangement can be adjusted to several shading positions in the guiding rails. For example, adjustment of the shading positions can be continuous or rasterized. The corresponding latching units are provided for this purpose.

In one embodiment, the guiding rails are configured parallel to the guiding arrangement. Alternatively, the guiding rails are situated so as to converge toward each other. In such an embodiment, the shading arrangement encompasses a compensating unit for offsetting the changing distance between the guiding rails.

Another embodiment of the shading system provides a cladding arrangement for at least partially cladding the guiding arrangement and/or restraining device. In one embodiment, the guiding rails of the guiding arrangement are at least partially clad, thereby ensuring that the guiding units of the shading arrangement will engage into the rail units, for example through oblong slits along the guiding rails. In another embodiment, the restraining device is at least partially clad. In a preferred embodiment of the cladding arrangement, both the guiding arrangement and restraining device are clad.

The shading system described above, in particular the first restraining arrangement, involves a disposable product or replacement part. After the restraining device has been used once for absorbing the kinetic energy of the shading arrangement, the absorption units are irreversibly deformed, and should be replaced accordingly. The entire guiding arrangement along with the guiding rails and the first and second restraining arrangement are changed out in the process. The frame is here preferably designed as a single piece. The absorption units or the first restraining arrangement is integrated into the frame or one-piece guiding arrangement, in particular configured as a single piece or rigidly connected. In another embodiment, the shading arrangement is also replaced. In yet another embodiment, the absorption units are replaceably joined with the guiding arrangement.

One embodiment of the shading system provides that the first restraining arrangement on the guiding arrangement be configured to indirectly absorb the kinetic energy. The kinetic energy is absorbed directly. In one embodiment, the first restraining arrangement, more precisely the absorption units, is integrated into the guiding rails of the guiding arrangement. The absorption units are preferably situated on a front end of the guiding rails viewed in the direction of movement of the shading arrangement, meaning integrated to a front of the motor vehicle.

Another embodiment of the shading system provides that the second restraining arrangement on the shading arrangement be configured to directly absorb the kinetic energy. The kinetic energy is absorbed indirectly, meaning by means of interposed components, for example the absorption units. In one embodiment, the second absorption takes place directly by tightening up the safety belt, without interposed components.

In a motor vehicle encompassing at least one shading means, the shading means is configured like the shading system described above. For example, the motor vehicle can be a sedan, SUV, station wagon, sports car, minivan, etc. The shading system is accommodated under a roof of the motor vehicle. For example, the roof takes the form of a translucent panoramic roof. The shading system shields the vehicle interior from incident light. To this end, the shading arrangement of the shading system is shifted into any shading position desired. The shading system is shifted along a longitudinal axis of the motor vehicle, meaning from the rear to the front of the motor vehicle, and vice versa. The roof of the motor vehicle remains closed in the process. An additional roof opening independent of the shading system is possible.

A motor vehicle equipped with the shading system described above offers additional passenger protection. The shading arrangement remains mounted in the guiding arrangement even during high negative accelerations, for example in case of an accident, and is not hurled through the vehicle interior or even thrown out of the latter, so that passengers are not faced with any additional risk of injury. The accelerations or movements described within the framework herein involve accelerations or movements that arise in the shifting direction of the shading arrangement.

For example, the shading system is coupled with the onboard electronics of the motor vehicle, e.g., for turning the shading system on and/or off, and/or for further coupling with other safety arrangements, such as an airbag or accelerometer.

In addition, a method for absorbing the kinetic energy of a shading arrangement of a shading system, in particular a roof shading system in a motor vehicle, encompasses at least the steps of absorbing a first portion of kinetic energy in a first absorption step through plastic deformation and/or absorbing a second portion of kinetic energy in a second absorption step through restraint with a safety belt, so that a two-stage, coupled absorption of kinetic energy takes place. The absorption of kinetic energy with the restraining device is accomplished by establishing a sequential coupling, i.e., a sequential, functional connection, between the two restraining arrangements. While one embodiment here also allows the absorption stages to overlap, any overlap is preferably avoided so as to fully exploit the respective absorptive capacity of the restraining arrangements.

In one embodiment, the first absorption step is performed by at least partially deforming the absorption unit. The second absorption step is, for example, performed by restraining the safety belt. As a consequence, the restraining arrangements ensure a two-stage absorption, wherein it is preferred that the kinetic energy be absorbed in the first stage via the first restraining arrangement by deforming the absorption unit, and in the second stage via the second restraining arrangement by tightening the safety belt. The kinetic energy is completely absorbed, with a majority of the kinetic energy being absorbed in the first stage.

At least 50%, for example at least 75%, such as at least 90%, of all the kinetic energy of the shading arrangement is absorbed in the first stage. The remaining kinetic energy is absorbed in the second stage. In one embodiment, the second stage is omitted if the percentage of kinetic energy absorbed in the first phase measures over 90%.

An embodiment of the method here provides that the restraint take place after an adjustment has been made to the deformation by setting the length of the safety belt. In particular, the length of the safety belt is adjusted in such a way that the safety belt only starts tightening after the first deformation stage has concluded, so as to enable the maximum absorption of kinetic energy for the two stages. The deformation is concluded via this adjustment, meaning that the maximum braking effect has been reached before the belt restraint is initiated.

### BRIEF DESCRIPTION OF THE DRAWINGS

The various embodiments will hereinafter be described in conjunction with the following drawing figures, wherein like numerals denote like elements, and wherein:

FIG. 1 is a diagrammatic, perspective view of a shading system with a restraining device;

FIG. 2 is a diagrammatic partial view of the shading system with the shading arrangement depicted in two shading positions and the restraining device according to FIG. 1 with detail A;

FIG. 3 is a diagrammatic, perspective view of an absorption unit designed as a holder in a first embodiment;

FIG. 4 is a diagrammatic, perspective view of an absorption unit designed as a holder in a further embodiment; and

FIG. 5 is a magnified, diagrammatic perspective view of detail A according to FIG. 2.

### DETAILED DESCRIPTION

The following detailed description is merely exemplary in nature and is not intended to limit the various embodiments or the application and uses thereof. Furthermore, there is no intention to be bound by any theory presented in the preceding background or summary or the following detailed description.

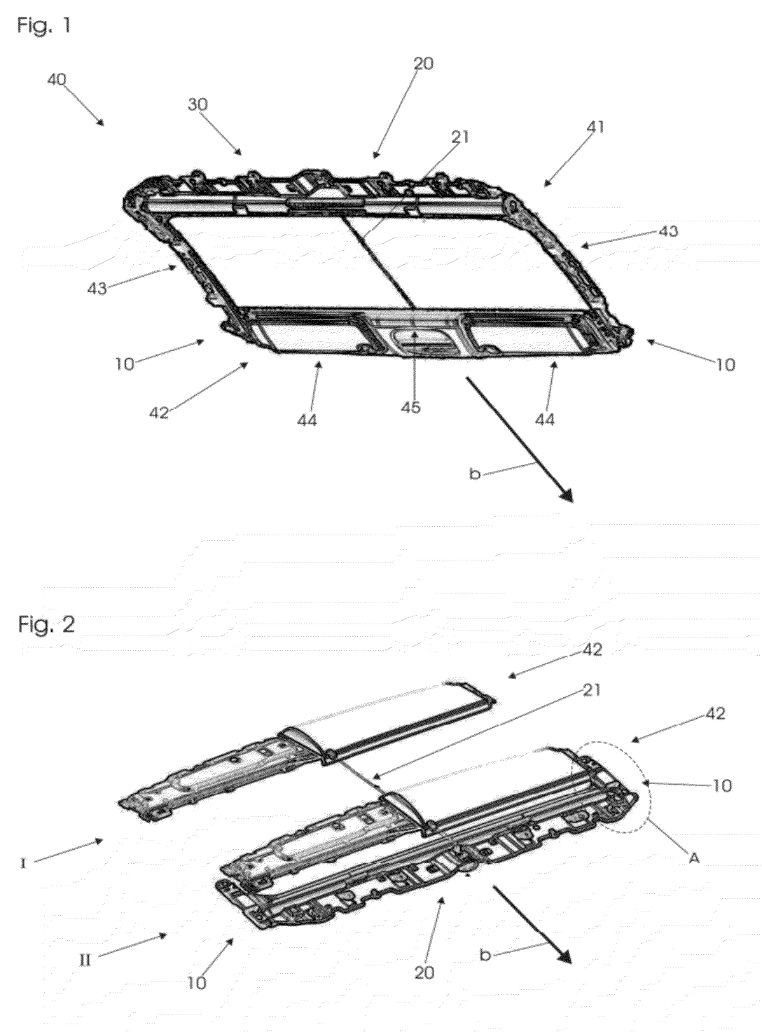

FIG. 1 shows a diagrammatic, perspective view of a shading system 40 with a restraining device 30. The shading system 40 is configured as an overhead shading system for a motor vehicle (not shown). FIG. 1 depicts the shading system 40 through the eyes of a passenger, i.e., at an inclination from below. The shading system 40 encompasses a shading arrangement 42 for at least partially shading passengers (not shown) and a guiding arrangement 41 designed like a quadrangular frame for accommodating and sliding the shading arrangement 42. The shading arrangement 42 is situated on the roof of the motor vehicle, wherein the guiding arrangement 41 is secured under the roof of the motor vehicle. In order to provide a better view, FIG. 1 does not show a motor vehicle or a roof of a motor vehicle. The shading arrangement 42 is bilaterally and slidably mounted in two guiding rails 43 of the guiding arrangement 41. For this purpose, the shading arrangement 42 exhibits the corresponding guiding units (not shown).

In addition, the shading system 40 encompasses the restraining device 30. The restraining device 30 is used to absorb the kinetic energy of the shading arrangement 42 given an unforeseen movement, i.e., one that was not intentionally initiated, for example. The restraining device 30 encompasses a first restraining arrangement 10, so as to absorb at least a first portion of the kinetic energy through at least a partial deformation. In addition, the restraining device 30 encompasses a second restraining arrangement 20, so as to absorb at least a second portion of the kinetic energy. The first restraining arrangement 10 and second restraining arrangement 20 are essentially functionally connected in sequence, so as to ensure a dual action to absorb all kinetic energy.

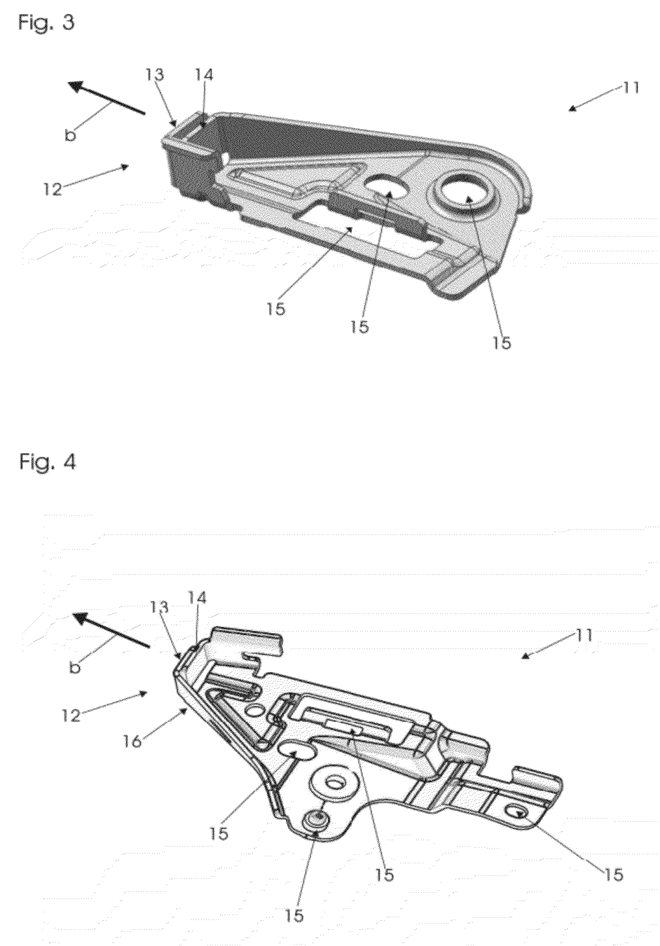

The first restraining arrangement 10 is configured as two plastically deformable absorption units 11 (FIG. 3 and FIG. 4). The absorption units 11 are situated on a front end of the guiding rails 43 viewed in the direction of the unforeseen movement (denoted with arrow b) of the shading arrangement 42, which is positioned in the direction of the front of a motor vehicle. As a consequence, the absorption units 11 are provided on both sides of the shading arrangement 42. The absorption units 11 absorb as much of the kinetic energy as possible by undergoing plastic deformation. The kinetic energy of the shading arrangement 42 is here converted into deformation energy and heat. The amount of absorbed energy here depends on a deformation path, i.e., on the level of deformation. For example, the absorption units 11 are designed as holders. The holders of absorption units 11 on FIGS. 3 and 4 will be described in detail below.

In the embodiment on FIG. 1, the second restraining arrangement 20 is designed as at least one belt system resembling a seat belt system with unwindable safety belt 21. The belt system is situated in about the middle of the shading arrangement 42 viewed in the width direction. The belt system here encompasses an unwindable safety belt 21, a fixed attachment of the safety belt 21 to the shading arrangement 42, and a movable, i.e., roll-up and roll-down, attachment to the guiding arrangement 41, for example on a winding unit in the form of a roller. The length of the safety belt 21 is here tailored to the maximum deformation path of the absorption units 11, so as to ensure a seamless absorption of kinetic energy by the first and second restraining arrangement 10 and 20.

In addition, the shading arrangement 42 also encompasses a sunshade unit 44 in the form of two folding sunshades, and a gripping unit 45 for manually sliding the shading arrangement 42 forward and backward.

FIG. 2 shows a diagrammatic partial view of the shading system 40 with the shading arrangement 42 depicted in two shading positions I and II, and of the restraining device 30 according to FIG. 1 with detail A. The shading system 40 on FIG. 2 basically corresponds to the shading system 40 on FIG. 1. The same components are marked with the same reference numbers. Therefore, no detailed description of components already described will be provided. The shading system 40 on FIG. 2 is shown at an inclination from above, i.e., the side opposite the bottom side depicted on FIG. 1. In addition, the shading arrangement 42 is shown in two different shading positions I and II. Shading position I represents the position of the shading arrangement 42 before an unforeseen movement. Shading arrangement 42 is in a rear position. Shading position II represents the position of the shading arrangement 42 after an unforeseen movement, meaning after the kinetic energy has been slowed down or absorbed by the restraining device 10. After it has been slowed down, the shading arrangement 42 is situated at a front end of the guiding arrangement 41. The restraining arrangements 10 and 20 respond in front shading position II, thereby preventing the shading arrangement 42 from continuing to move forward, in the direction of a windshield of the motor vehicle.

FIGS. 3 and 4 each present a diagrammatic perspective view of a holder for the absorption unit 11 in two different embodiments. The holders on FIGS. 3 and 4 are essentially mirror images of each other. The holder on FIG. 3 is configured for a right side (in the direction of movement, marked with arrow b) of the guiding arrangement 41, and the holder on FIG. 4 is configured for a left side (in the direction of movement, marked with arrow b) of the guiding arrangement 41. A top view reveals that the holders exhibit roughly a basic triangular shape with various impressions and moldings. Among other things, several different attachment openings 15 are provided for securing to guiding arrangement 41. For example, the holders are screwed and/or welded to the guiding arrangement 41. The front areas of the holders comprise the actual deforming regions 12, which undergo plastic deformation while the kinetic energy of the shading arrangement 42 is being absorbed (respective left side of figure). The deforming regions 12 are each two-ply, folded and comprised of a first deforming piece 13 and second deforming piece 14. The deforming regions 12 differ in terms of how the deforming pieces 13 and 14 fold, among other things.

In the deforming region 12 of the holder on FIG. 3, the first deforming piece 13 is folded on the outside, and the second deforming piece 14 is folded on the inside. During the absorption process, the shading arrangement 42 abuts directly against the interior, second deforming piece 14, which deforms together with the exterior, first deforming piece 13 in the direction of movement (arrow b). The achieved kinetic energy braking or absorption effect here measures distinctly less than 90%, so that the second restraining arrangement 20 is connected downstream from the first restraining arrangement 10 as the second stage.

By contrast, in the deforming region 12 of the holder on FIG. 4, the first deforming piece 13 is situated inside, and the second deforming piece 14 is situated outside. The second deforming piece 14 is reinforced by an additional holding flange 16. During the absorption process, the shading arrangement 42 directly abuts against the interior, first deforming piece 14. Because it is reinforced with the holding flange 16, the exterior, first deforming piece 13 prevents a strong forward deformation (direction of movement marked with arrow b). The second deforming piece 14 with the holding flange 16 prevents the first deforming piece 13 from completely deforming or folding out. By comparison to the embodiment on FIG. 3, the absorption of kinetic energy is so elevated in the embodiment on FIG. 4 that the second restraining arrangement can be omitted.

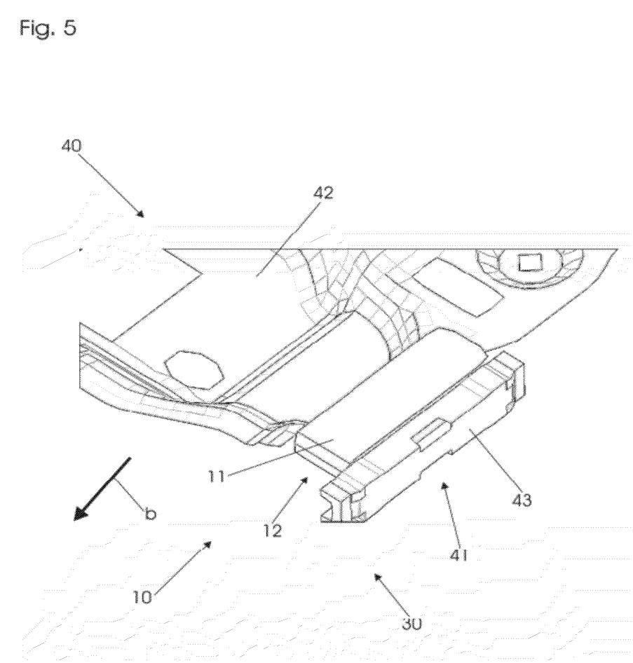

FIG. 5 shows a magnified, diagrammatic perspective view of detail A on FIG. 2. Detail A depicts a section of the shading arrangement 42 with the absorption unit 11 of the first restraining arrangement 10 and the guiding rail 43 of the guiding arrangement 41 as part of the shading system 40. The shading system 40 and restraining device 30 correspond to those on FIGS. 1 and 2. During the absorption process, the shading arrangement 42 is accommodated by the absorption unit 11 in the direction of movement (arrow b). The absorption unit 11 slows down the shading arrangement 42 through the absorption of kinetic energy or deformation of its deforming region 12.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A restraining device of a shading system for absorbing a kinetic energy of a slidable shading arrangement given an unforeseen movement, the restraining device comprising:
a first restraining arrangement configured to absorb a first portion of the kinetic energy by at least partially deforming.

2. The restraining device according to claim 1, wherein the shading system is an overhead shading system in a motor vehicle.

3. The restraining device according to claim 1, wherein the first restraining arrangement comprises a plastically deformable absorption unit.

4. The restraining device according to claim 1, further comprising a second restraining arrangement configured to absorb a second portion of the kinetic energy.

5. The restraining device according to claim 4, wherein the first restraining arrangement and the second restraining arrangement are at least partially functionally connected in sequence so that all the kinetic energy is absorbed.

6. The restraining device according to claim 4, wherein the second restraining arrangement comprises a belt system resembling a seat belt system with an unwindable safety belt.

7. The restraining device according to claim 6, wherein the first restraining arrangement comprises a plastically deformable absorption unit and wherein a length of the unwindable safety belt has a deformation path of the plastically deformable absorption unit, so as to ensure a seamless absorption of the kinetic energy.

8. The restraining device according to claim 4, wherein the second restraining arrangement comprises a brake system chosen from a centrifugal clutch and cable brake.

9. The restraining device according to claim 1, further comprising a switch unit for switching the restraining device.

10. A motor vehicle having a shading system, the shading system comprising:
a roof shading arrangement for at least partially shading at least one passenger compartment of the motor vehicle;
a guiding arrangement situated under a roof of the motor vehicle for slidably accommodating the roof shading arrangement; and
a restrainer for absorbing a kinetic energy of the roof shading arrangement given an unforeseen movement, wherein the restrainer includes a restraining device comprising:
a first restraining arrangement configured to absorb a first portion of the kinetic energy by at least partially deforming.

11. The motor vehicle according to claim 10, wherein the shading system is an overhead shading system for the motor vehicle.

12. The motor vehicle according to claim 10, further comprising a second restraining arrangement configured to absorb a second portion of the kinetic energy.

13. The motor vehicle according to claim 12, wherein the first restraining arrangement is configured to indirectly absorb the kinetic energy.

14. The motor vehicle according to claim 13, wherein the second restraining arrangement is configured to directly absorb the kinetic energy.

15. The motor vehicle according to claim 12, wherein the first restraining arrangement and the second restraining arrangement are at least partially functionally connected in sequence so that all the kinetic energy is absorbed.

16. The motor vehicle according to claim 12, wherein the second restraining arrangement comprises a belt system resembling a seat belt system with an unwindable safety belt.

17. The motor vehicle according to claim 16, wherein the first restraining arrangement comprises a plastically deformable absorption unit and wherein a length of the unwindable safety belt has a deformation path of the plastically deformable absorption unit, so as to ensure a seamless absorption of the kinetic energy.

18. A method for absorbing a kinetic energy of a shading arrangement of a shading system, in particular a roof shading system in a motor vehicle, the method comprising the steps of:
absorbing a first portion of kinetic energy through plastic deformation and/or absorbing a second portion of kinetic energy through restraint with a safety belt,
wherein a two-stage, coupled absorption of kinetic energy takes place.

19. The method according to claim 18, further comprising adjusting the plastic deformation by setting a length of the safety belt before the restraint takes place.
